(19) United States
(12) Patent Application Publication
(10) Pub. No.: US 2025/0055547 A1
(43) Pub. Date: Feb. 13, 2025

(54) METHODS AND APPARATUS FOR DETERMINATION OF ACCESS LINK DIRECTIONAL BEAMS FOR SMART REPEATER IN WIRELESS COMMUNICATION

(71) Applicant: APPLE INC., Cupertino, CA (US)

(72) Inventors: Hong HE, San Jose, CA (US); Chunxuan YE, San Diego, CA (US); Dawei ZHANG, Saratoga, CA (US); Haitong SUN, Cupertino, CA (US); Jie CUI, San Jose, CA (US); Oghenekome OTERI, San Diego, CA (US); Seyed Ali Akbar FAKOORIAN, San Diego, CA (US); Sigen YE, San Diego, CA (US); Wei ZENG, Saratoga, CA (US); Weidong YANG, San Diego, CA (US)

(21) Appl. No.: 18/722,308

(22) PCT Filed: Dec. 9, 2022
(86) PCT No.: PCT/US2022/081237

§ 371 Date: Jun. 20, 2024

Related U.S. Application Data
(60) Provisional application No. 63/266,467, filed on Jan. 6, 2022.

(51) Int. Cl. H04B 7/06; H04B 7/155

(52) U.S. Cl. CPC H04B 7/0695; H04B 7/0617; H04B 7/155

(57) ABSTRACT

Systems and method are provided for determining access link direction beams for smart repeaters (SMRs). An SMR may be configured with a set of SMR transmission beam indicator (TBI) state (SMR-TBI State) configurations. The SMR-TBI State configurations in the set respectively comprise an SMR-TBI State identifier (ID), a cell index, and a reference signal associated with a beam for an access link between the SMR and a user equipment (UE). The SMR may receive, through a backhaul link from a base station, an indication of one or more active SMR-TBI States. For at least one of the one or more active SMR-TBI States, the SMR may forward a signal between the base station and the UE using the beam associated with the reference signal in a corresponding SMR-TBI State configuration.

### TECHNICAL FIELD

This application relates generally to wireless communication systems, including wireless communications systems having smart repeaters (SMRs) that relay information between one or more user equipments and a base station.

### BACKGROUND

Wireless mobile communication technology uses various standards and protocols to transmit data between a base station and a wireless communication device. Wireless communication system standards and protocols can include, for example, 3rd Generation Partnership Project (3GPP) long term evolution (LTE) (e.g., 4G), 3GPP new radio (NR) (e.g., 5G), and IEEE 802.11 standard for wireless local area networks (WLAN) (commonly known to industry groups as Wi-Fi®).

As contemplated by the 3GPP, different wireless communication systems standards and protocols can use various radio access networks (RANs) for communicating between a base station of the RAN (which may also sometimes be referred to generally as a RAN node, a network node, or simply a node) and a wireless communication device known as a user equipment (UE). 3GPP RANs can include, for example, global system for mobile communications (GSM), enhanced data rates for GSM evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the base station and the UE. For example, the GERAN implements GSM and/or EDGE RAT, the UTRAN implements universal mobile telecommunication system (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A base station used by a RAN may correspond to that RAN. One example of an E-UTRAN base station is an Evolved Universal Terrestrial Radio Access Network (E-UTRAN) Node B (also commonly denoted as evolved Node B, enhanced Node B, eNodeB, or eNB). One example of an NG-RAN base station is a next generation Node B (also sometimes referred to as a or g Node B or gNB).

A RAN provides its communication services with external entities through its connection to a core network (CN). For example, E-UTRAN may utilize an Evolved Packet Core (EPC), while NG-RAN may utilize a 5G Core Network (5GC).

Frequency bands for 5G NR may be separated into two or more different frequency ranges. For example, Frequency Range 1 (FR1) may include frequency bands operating in sub-6 GHz frequencies, some of which are bands that may be used by previous standards, and may potentially be extended to cover new spectrum offerings from 410 MHz to 7125 MHz. Frequency Range 2 (FR2) may include frequency bands from 24.25 GHz to 52.6 GHz. Note that in some systems, FR2 may also include frequency bands from 52.6 GHz to 71 GHz (or beyond). Bands in the millimeter wave (mmWave) range of FR2 may have smaller coverage but potentially higher available bandwidth than bands in FR1. Skilled persons will recognize these frequency ranges, which are provided by way of example, may change from time to time or from region to region.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 is a block diagram illustrating a wireless network including a base station and an SMR for communicating with a UE in accordance with one embodiment.

FIG. 2 is a table illustrating an SMR-TBI State parameter structure for SMR beam forwarding indication in accordance with one embodiment.

FIG. 3 illustrates an SMR-TBI States Activation/Deactivation MAC CE for beam forwarding operation in accordance with one embodiment.

FIG. 4 illustrates a DCI format (i.e., DCI Format 2_X) for SMR-TBI State activation/deactivation for beam formed fixed wireless forwarding (FWF) operation in accordance with one embodiment.

FIG. 5 is a block diagram illustrating an example of SMR-TBI State activation and deactivation for beam formed forwarding operation in accordance with one embodiment.

FIG. 6 is a block diagram illustrating example signaling of a dedicated SMR-TBI configuration by RRC signaling through a backhaul link to an SMR in accordance with one embodiment.

FIG. 7 illustrates an example of both a DL slot and a UL slot within a duration of an SMR-TBI State in accordance with one embodiment.

FIG. 8 illustrates example semi-statically configured SMR-TBI patterns for access links in accordance with one embodiment.

FIG. 9 is a table illustrating an SMR-TBI Sate combination structure in accordance with one embodiment.

FIG. 10 illustrates an example DCI Format 2_Y for SMR-TBI State update in accordance with one embodiment.

FIG. 11 and FIG. 12 illustrate an example of dynamic SMR-TBI signaling for FWF beam indication in accordance with one embodiment.

FIG. 13 illustrates a method for an SMR in accordance with one embodiment.

FIG. 14 illustrates a method for a base station in accordance with one embodiment.

FIG. 15 illustrates an example architecture of a wireless communication system, according to embodiments disclosed herein.

FIG. 16 illustrates a system for performing signaling between a wireless device and a network device, according to embodiments disclosed herein.

### DETAILED DESCRIPTION

Various embodiments are described with regard to a UE. However, reference to a UE is merely provided for illustrative purposes. The example embodiments may be utilized with any electronic component that may establish a connection to a network and is configured with the hardware, software, and/or firmware to exchange information and data with the network. Therefore, the UE as described herein is used to represent any appropriate electronic component.

UE coverage is a fundamental aspect of wireless communication system deployments. Mobile operators may rely on different types of network nodes to offer blanket coverage in their deployments. The deployment of full-stack cells within a wireless communication system is one option for providing UE coverage, but this may not be always possible or economically viable in every location (e.g., in cases where there is no availability of a backhaul from the location to the core network, and/or an unreasonable amount of expense for establishing such a backhaul and/or the full-stack cell). As a result, new types of network nodes are considered to increase mobile operators' flexibility for their wireless communication system network deployments.

One such example of these new network nodes is the smart repeater (SMR). Note that the other terms maybe used for SMR (e.g., network-controlled repeater or network-assisted repeater), where embodiments disclosed herein can be directly used. Hereinafter, the SMR is used to describe the embodiments. However, the disclosure is not so limited. An SMR may establish a wireless connection (which may be referred to herein as a “backhaul link”) between the SMR and a base station. The SMR may also establish a wireless connection (which may be referred to herein as an “access link”) between the one or more UEs and the SMR. Thus, the SMR may communicate or forward signals back and forth between the one or more UEs and the base station. This may be useful in the case where, for example, the base station (e.g., having the backhaul to the core network of the wireless communication system) cannot directly serve the UE (e.g., due to distance and/or interference and/or shadow fading caused by buildings), but the SMR can directly serve the UE. The backhaul link between the SMR and the base station may be possible because of, for example, an ability of the SMR and/or the base station to use a necessary transmission power and/or more accurate and/or precise beamforming (e.g., greater/better than that which can reasonably be provided for a regular use case of a UE). Through this relaying between the SMR and the base station, the effective possible coverage range and/or performance for the UE within the wireless communication network is improved. Note that such interference considerations may be particularly relevant in the case of higher frequency operation of the base station and/or the SMR (e.g., in FR2), due to the tendency of such relatively higher frequency signaling to be more impacted by interference sources and/or to have a lesser transmission range than relatively lower frequency signaling.

An SMR may itself be enhanced over conventional radio frequency (RF) repeaters with the capabilities to receive, process, and implement side control information or SMR control information from the network (e.g., as received from the base station). Among other things, SMR control information could allow an SMR to perform any amplify-and-forward operations in a more efficient manner. Potential benefits stemming from the use of such SMR control information may include mitigation of unnecessary noise amplification, better spatial directivity for SMR transmissions and/or receptions, and/or simplified network integration between the SMR and a base station.

An SMR may be capable of sending beamformed signals to one or more of the UEs that it serves. It is contemplated that one or more of the above benefits could be achieved by using SMR control information to enable network control (at least in part) of beamforming operation at an SMR. Accordingly, disclosed herein are embodiments that enable an efficient and flexible beam management for the data communication between an SMR and SMR-UEs in its coverage over an access link.

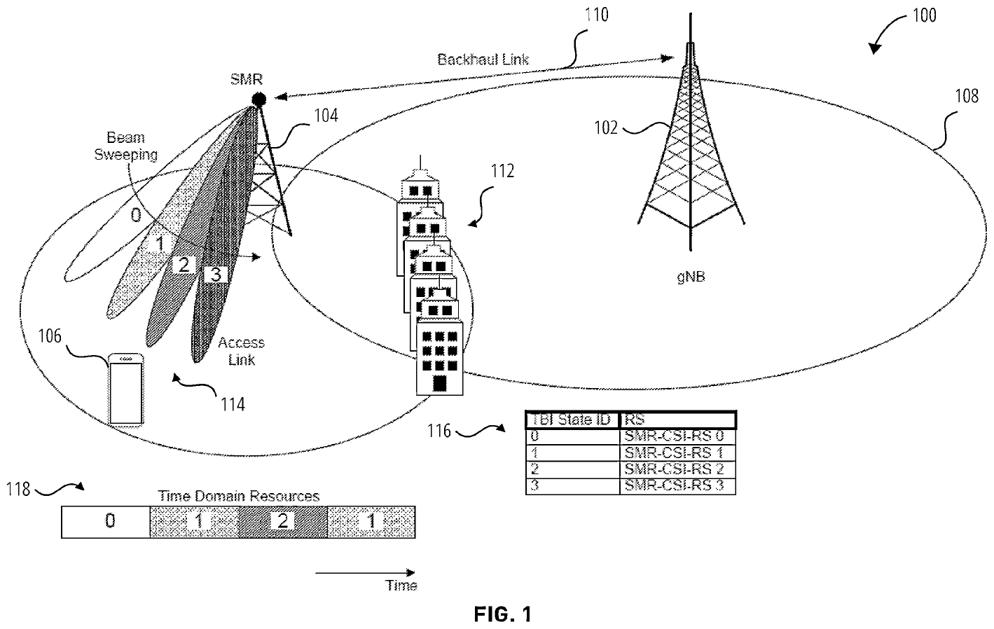

FIG. 1 is a block diagram illustrating a wireless network 100 including a base station 102 (shown as a gNB) and an SMR 104 for communicating with a UE 106 according to one embodiment. The SMR 104 is in coverage range 108 of, and established a connection or backhaul link 110 with, the base station 102. It may be that even though the UE 106 is theoretically within the coverage range 108 of the base station 102, direct signaling between the UE 106 and the base station 102 may not be accomplished due to interference of obstructions 112 (which have been illustrated as buildings, but could alternatively be other man-made items, or natural/geographical features or events). Accordingly, coverage for the UE 106 is provided by the SMR 104 through an access link 114. Thus, the SMR 104 uses the access link 114 and the backhaul link 110 to relay downlink (DL) and/or uplink (UL) signals between the base station 102 and the UE 106.

Through the backhaul link 110, the SMR 104 may report a beam forming capability or a maximum number of SMR-TBI States capability per component carrier (CC) for a DL forwarding operation and/or an UL forwarding operation. In response, the base station 102 may configure the SMR 104 with a list of up to M SMR transmission beam indicator (TBI) state (SMR-TBI State) configurations, where M may depend on the beam forming capability or the maximum number of SMR-TBI States capability reported by the base station 102. The SMR 104 may then perform beam sweeping to establish the access link 114 with the UE 106. Skilled persons will recognize from the disclosure herein that the SMR 104 may establish wireless connections with more than one UE and that the base station 102 may also establish wireless connections with a plurality of UEs (not shown).

Beam sweeping is a technique that transmits different downlink signals or channels in a burst in different beamformed directions. A synchronization signal block (SSB) beam sweep (or beam sweep for SSB transmissions), for example, may include the transmission of one or more SSBs of an SSB burst set using one or more associated beams in different transmission directions. SSB beam sweeps are used in wireless communication systems to enable a receiving UE to use the beam-associated SSBs to determine synchronization with the cell and directionality of signaling to/from the UE on the cell (among other things). Similarly, a channel state information (CSI) reference signal (RS) beam sweep may include the transmission of one or more CSI-RS resources of a CSI-RS resource set on one or more associated DL beams. Each beam may include one of the one or more CSI-RS resources and may be transmitted in a unique direction. CSI-RS resource(s) of the CSI-RS beam sweep that are received at a UE may be used in wireless communications networks to enable the UE to fine tune its beamforming with the transmitting entity and/or to provide feedback regarding the received CSI-RS resources to the network such that a beamforming of the transmitting entity can be more finely tuned (among other things). This process may be performed to fine tune previously established beam(s) between the transmitting entity and the UE (e.g., as may have been established through the use of an SSB beam sweep operation).

For the access link 114 shown in FIG. 1, the SMR 104 determines the transmission beam for the DL signal forwarding or the reception beam for the uplink signals based on a non-zero power channel state information reference signal transmitted by SMR (SMR-NZP-CSI-RS) resource or a synchronization signal block transmitted by SMR (SMR-SSB) associated with a TBI state provided in higher layer signaling or downlink control information (DCI) Format 2_X, as disclosed in detail below. Either an SMR-SSB or a SMR-CSI-RS is associated with a specific TBI state with dedicated TBI state identifier (ID).

In the example shown in FIG. 1, the SMR 104 is configured with M=4 SMR-TBI State configurations with each TBI state being associated with an SMR-NZP-CSI-RS using different DL transmission beams. As shown in list 116, TBI state ID 0 is associated with SMR-CSI-RS 0, TBI state ID 1 is associated with SMR-CSI-RS 1, TBI state ID 2 is associated with SMR-CSI-RS 2, and TBI state ID 3 is associated with SMR-CSI-RS 3.

In this example, the base station 102 indicates different SMR-TBI States {0,1,2,1} for different time domain resources 118. The SMR 104 then forwards the DL signal using the same transmission direction as SMR-NZP-CSI-RS {0,1,2,1} accordingly for the associated SMR-UEs (including the UE 106).

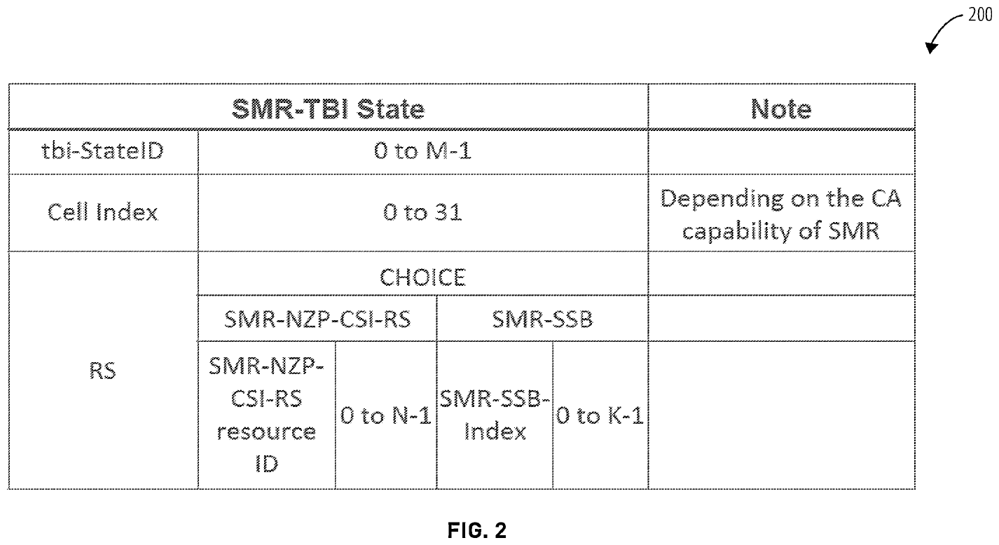

FIG. 2 is a table 200 illustrating an SMR-TBI State parameter structure for SMR beam forwarding indication according to one embodiment. As shown, each SMR-TBI State includes a TBI-State ID (tbi-StateID) in a range from 0 to M-1, a cell index in a range (for example) of 0 to 31 depending on the carrier aggregation (CA) capability of the SMR 104, and an RS selected by the base station 102 (i.e., “choice”) from either an SMR-NZP-CSI-RS or an SMR-SSB. The base station 102 may indicate the SMR-NZP-CSI-RS with an SMR-NZP-CSI-RS resource ID in a range from 0 to N-1. The base station 102 may indicate the SMR-SSB with an SMR-SSB index in a range from 0 to K-1.

### SMR-TBI State Activation/Deactivation

In certain embodiments disclosed herein, a base station (e.g., gNB) may activate and deactivate the configured SMR-TBI States for DL and/or UL beam-based forwarding operation at an SMR for a serving cell or a set of serving cells configured by radio resource control (RRC) signaling. The configured SMR-TBI States may be initially deactivated upon configuration by the base station.

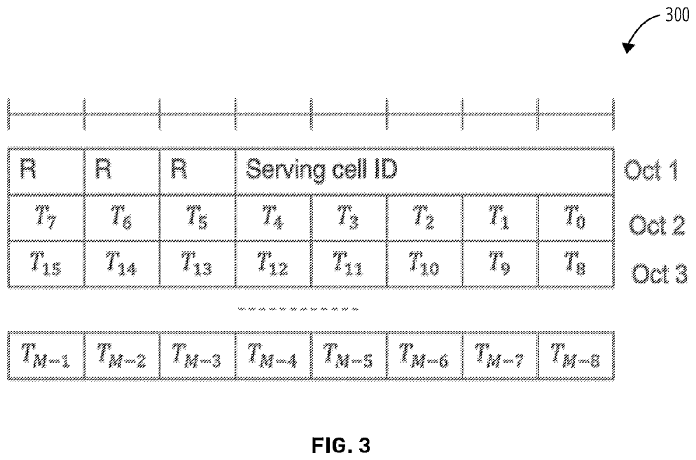

In certain embodiments, the activation and deactivation of SMR-TBI States for a SMR may be triggered by a media access control (MAC) control element (CE), which may be referred to herein as an SMR-TBI States Activation/Deactivation MAC CE. For example, FIG. 3 illustrates an SMR-TBI States Activation/Deactivation MAC CE 300 for beam forwarding operation according to one embodiment. The SMR-TBI States Activation/Deactivation MAC CE 300 may be identified by a MAC subheader with a dedicated logical channel ID (LCID). The SMR-TBI States Activation/Deactivation MAC CE 300 may have a variable size and include a serving cell ID field and a plurality of Tᵢ fields. In this example, the serving cell ID field is shown with reserved bits “R” in a first octet (Oct 1) and the plurality of Tᵢ fields are shown in a second octet (Oct 2), a third octet (Oct 3), etc. Skilled persons will recognize from the disclosure herein, however, that other configurations are also possible (e.g., more or fewer reserved bits, including no reserved bits, may be used).

The serving cell ID field indicates the identity of the serving cell for which the MAC CE applies. In certain embodiments, if the indicated serving cell is configured as part of a serving cell group that includes a list of cells configured for a simultaneous SMR-TBI States update, then the MAC CE applies to all of the serving cells of SMR in the group.

Each Tᵢ field indicates the activation or deactivation status of the SMR-TBI State with SMR-TBI State ID i. For example, the base station may set the Tᵢ field to “1” to indicate that the SMR-TBI State with SMR-TBI State ID i is activated. Further, the base station may set the Tᵢ field to “0” to indicate that the SMR-TBI State with SMR-TBI State ID i is deactivated. In one embodiment, the codepoint to which the SMR-TBI-State is mapped may be determined by its ordinal position among the SMR-TBI States with Tᵢ field set to “1”. In other words, the first SMR-TBI State with field Tᵢ set to “1” is mapped to the codepoint value “0”, the second transmission configuration indicator (TCI) State with Tᵢ field set to “1” is mapped to the codepoint value “1” and so on.

In other embodiments, the activation and deactivation of SMR-TBI States for a SMR may be triggered by a DCI format, which may be referred to herein as DCI Format 2_X. The base station may transmit information using the DCI Format 2_X with cyclic redundancy check (CRC) bits scrambled by a TBI radio network temporary identifier (RNTI) that identifies the DCI format.

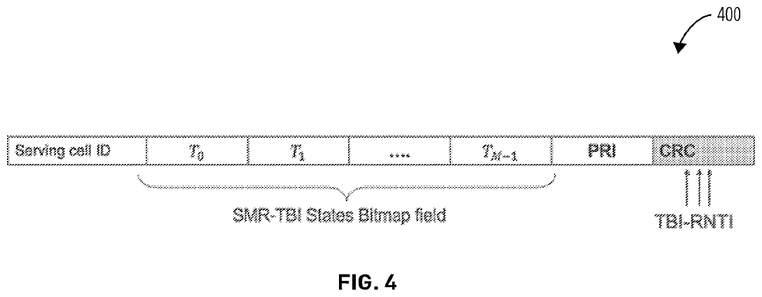

For example, FIG. 4 illustrates a DCI format 400 (i.e., DCI Format 2_X) for SMR-TBI State activation/deactivation for beam formed fixed wireless forwarding (FWF) operation according to one embodiment. As shown in the example of FIG. 4, the information transmitted using the DCI Format 2_X may include a serving cell ID, a bitmap field (also referred to as an SMR-TBI States bitmap field) where each bit corresponds to one Tᵢ field to indicate the activation/deactivation of SMR-TBI state with SMR-TBI State ID i, a physical uplink control channel (PUCCH) resource indicator (PRI) to indicate one PUCCH resource from a list of PUCCH resources configured by RRC signaling, and the CRC scrambled by the TBI-RNTI. The DCI Format 2_X may also include a function identifier for DCI formats that is used to identify the activation/deactivation function from other functions that share a same DCI Format 2_X. By way of example, for each bit of the bitmap field, a value of “1” may indicate that the associated SMR-TBI State is activated and a value of “0” may indicate that the associated SMR-TBI State is deactivated.

In certain embodiments, the SMR is provided with a search space set (SSS) configuration for DCI Format 2_X monitoring, which includes a set of parameters comprising a physical downlink control channel (PDCCH) monitoring periodicity, a PDCCH monitoring offset, and a control channel element (CCE) aggregation level of L_{TBI} CCEs of the SSS for detection of DCI Format 2_X. In some embodiments, the PDCCH monitoring periodicity and the PDCCH monitoring offset limit the monitoring occasion of the SSS to within the first three symbols of a single slot. In one embodiment, the L_{TBI} value may be predefined (e.g., in a specification or standard), for example, as one of the larger two values of <8, 16>. In another embodiment, the L_{TBI} value may be provided by the base station on a per SMR basis. In view of the reliability of a fixed gNB-SMR wireless link, in certain embodiments, the candidates for a given CCE aggregation level may be fixed or predetermined (e.g., 1), such as being defined in a specification or standard.

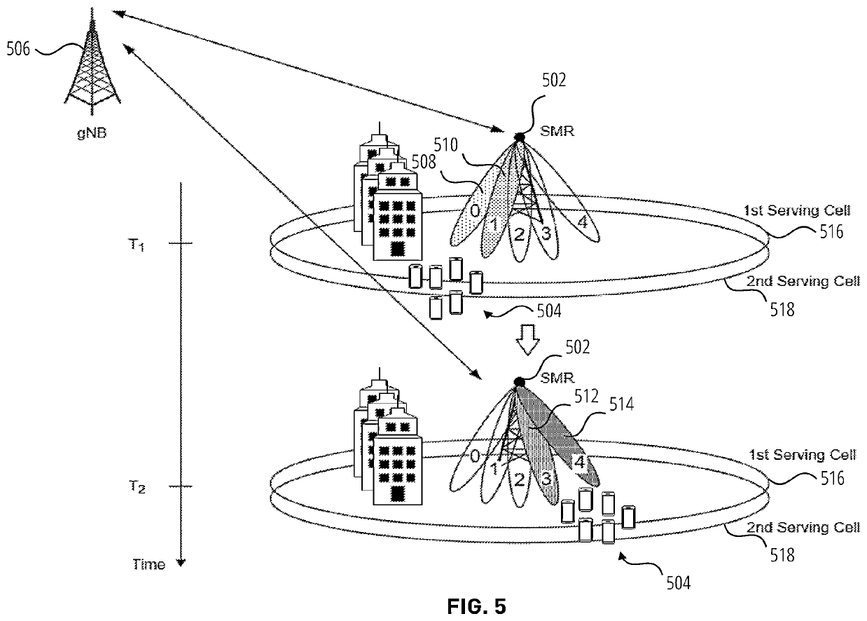

FIG. 5 is a block diagram illustrating an example of SMR-TBI State activation and deactivation for beam formed forwarding operation according to one embodiment. In this example, an SMR 502 is shown in communication with a plurality of UEs 504 at a first time (Tᵢ) and at a second time (T₂). The SMR 502 is capable of at least two active forwarding beams.

At the first time Tᵢ, a base station 506 (shown as a gNB) activates two forwarding beams 508, 510 that are associated with SMR-TBI State IDs <0, 1> (e.g., based on the beam measurement reporting from the plurality of UEs 504). At the second time T₂, the base station 506 deactivates the forwarding beams 508, 510 associated with SMR-TBI State IDs <0,1> and actives another two forwarding beams 512, 514 that are associated with SMR-TBI State IDs <3,4> for coverage extension (e.g., working time at Tᵢ and off-work time in bar at T₂).

Also in the example shown in FIG. 5, a first serving cell 516 and a second serving cell 518 are included in a group by RRC signaling, where an SMR-TBI States update is applied for all CCs in the group. As one consequence, forwarding beams 508, 510 that are associated with SMR-TBI State IDs <0,1> are activated at Tᵢ and deactivated at T₂ for both the first serving cell 516 and the second serving cell 518.

### Semi-Static SMR-TBI Signaling for FWF Beam Indication

In certain embodiments disclosed herein, an SMR may be provided with a dedicated SMR-TBI configuration for a number of time units. The time unit may be, for example, in a symbol or slot granularity to trade-off between signaling overhead and beam selection flexibility for FWF.

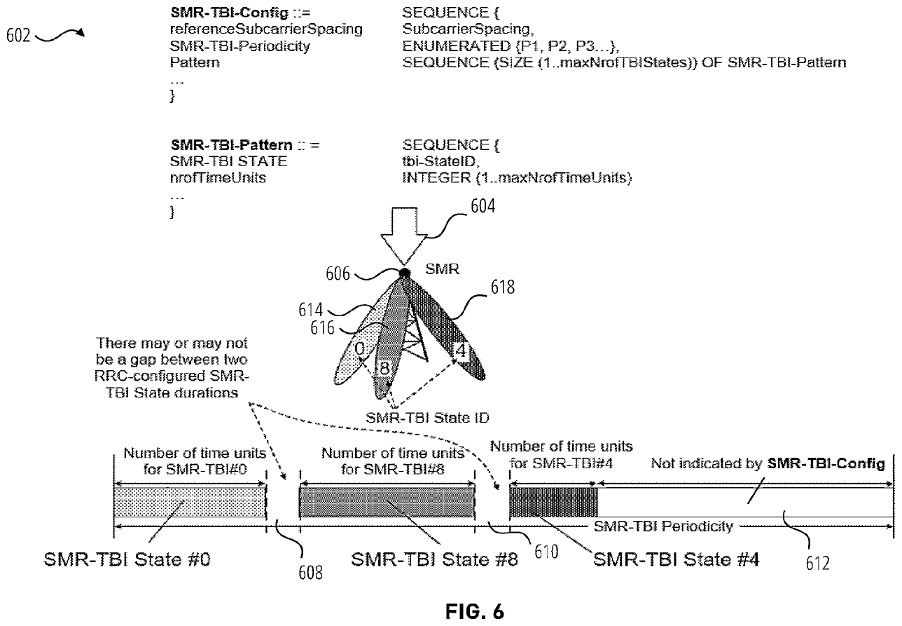

FIG. 6 is a block diagram illustrating example signaling of a dedicated SMR-TBI configuration 602 by RRC signaling through a backhaul link 604 to an SMR 606 according to one embodiment. The dedicated SMR-TBI configuration 602 may include a reference subcarrier spacing (SCS) configuration u_{ref} and an SMR-TBI pattern. The SCS configuration u_{ref} is used to determine the time domain boundaries for an associated SMR-TBI State. Alternatively, a predetermined reference SCS may be selected (e.g., from a specification or standard) for each frequency range (FR). For example, the SCS with the smallest u_{ref} value may be selected for each FR (e.g., 15 kHz SCS for FR1, 60 kHz for FR2-1, and 120 kHz for FR2-2).

The SMR-TBI pattern may be based on an SMR-TBI configuration period of P slots or P milliseconds. The SMR-TBI pattern may include a list of pairs <an SMR-TBI State, a number of time units (e.g., slots)>.

In the example shown in FIG. 6, three SMR-TBI States (corresponding to SMR-TBI State ID 0, SMR-TBI State ID 8, and SMR-TBI State ID 4) are indicated over an SMR-TBI configuration period (corresponding to the illustrated SMR-TBI periodicity) of P slots. Each of the indicated SMR-TBI IDs is associated with a respective number of time units, which may be the same as or different than the number of time units corresponding to other SMR-TBI IDs. The illustrated example includes gaps 608, 610 between consecutive SMR-TBI States and a plurality of time units 612 within the SMR-TBI configuration period that are not indicated by the dedicated SMR-TBI configuration 602 for an SMR-TBI State. However, as discussed below, certain embodiments do not include the gaps 608, 610. Within the SMR-TBI configuration period, the time units 612 that are not associated with any SMR-TBI State may be referred to herein as “flexible” time units.

Based on the SMR-TBI configuration, including the SMR-TBI pattern, the SMR 606 determines the directions of each access link beam 614, 616, 618 based on the indicated SMR-TBI States over the associated time units, respectively. The SMR 606 sets the transmission and reception beams for access link over the associated number of time units as indicated by the SMR-TBI pattern. For each pair <SMR-TBI State, number of time units>, the RS that is associated with the SMR-TBI State may be used to determine the DL transmission beams and UL reception beams of the access links between the SMR 606 and the SMR-UEs (not shown in FIG. 6) over the indicated time units.

Note that the DL/UL beam direction of the backhaul link 604 between the base station (not shown in FIG. 6) and the SMR 606 may be determined separately. Once determined, the DL/UL beam direction may be used by the SMR 606 for the backhaul link 604 unless a new beam is updated by a beam management procedure.

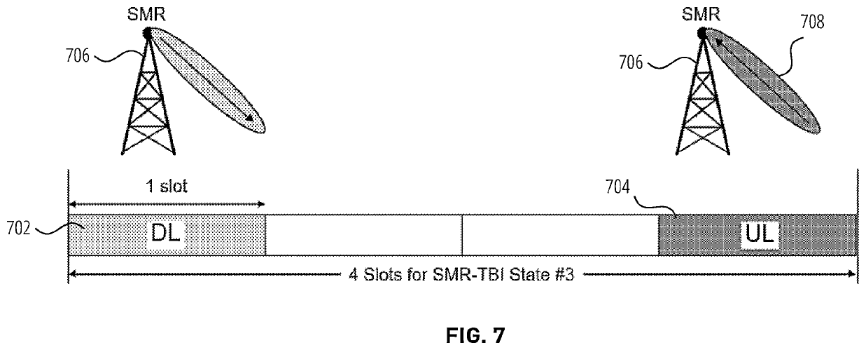

FIG. 7 illustrates an example of both a DL slot 702 and a UL slot 704 within a duration of an SMR-TBI State according to one embodiment. In this example, an SMR 706 determines a reception beam 708 for an access link over the UL slot 704 based on a measurement of the RS associated with the indicated SMR-TBI State #3.

A variety of embodiments may be used for the number of time units for each SMR-TBI State. In a first embodiment, for example, a set of time units associated with different SMR-TBI States are continuously allocated without a gap. In a second embodiment, a set of time units associated with different SMR-TBI States are not continuously allocated such that there is a gap. To include gaps, the SMR may be provided with a starting time unit (i.e., starting slot or starting symbol) in addition to the length (i.e., number of slots or symbols). In other embodiments, gaps may be included by using an offset parameter to indicate the starting time unit relative to the end of the previous SMR-TBI State.

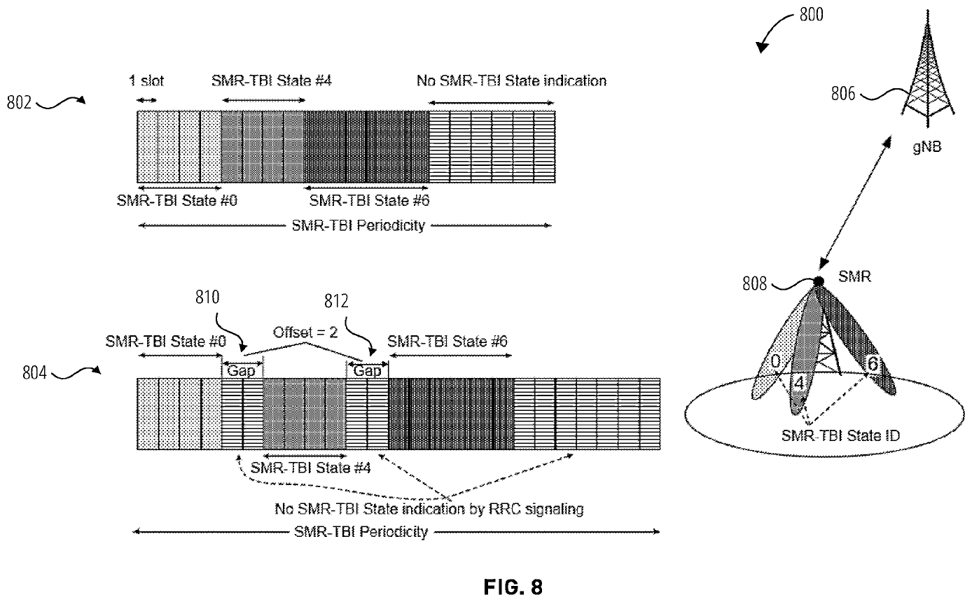

FIG. 8 illustrates example semi-statically configured SMR-TBI patterns 800 for access links according to certain embodiments. In this example, a first example embodiment 802 without gaps includes contiguous time units for consecutive SMR-TBI States in an SMR-TBI configuration, and a second example embodiment 804 with gaps includes noncontiguous time units for consecutive SMR-TBI States in an SMR-TBI configuration. The SMR-TBI periodicity is 20 slots for the first example embodiment 802 and 25 slots for the second example embodiment 804.

In the examples shown in FIG. 8, a base station 806 (shown as a gNB) provides an SMR 808 with three SMR-TBI States with different lengths or number of time units (e.g., based on traffic loads of UEs in different beams. In this example, SMR-TBI State #0 is indicated to be four slots, SMR-TBI State #4 is indicated to be four slots, and SMR-TBI State #6 is indicated to be six slots.

Thus, in the first example embodiment 802 based on the SMR-TBI configuration, the consecutive SMR-TBI States use contiguous slots without gaps, which leave six slots (flexible time units or flexible slots) with no SMR-TBI State indication within the SMR-TBI configuration period (corresponding to the illustrated SMR-TBI periodicity).

In the second example embodiment 804 based on the SMR-TBI configuration, the base station 806 further configures an offset of two slots for SMR-TBI State #4 and SMR-TBI State #6 to reserve a gap 810 between SMR-TBI State #0 and SMR-TBI State #4 and a gap 812 between SMR-TBI State #4 and SMR-TBI State #6. There is no SMR-TBI State indication by RRC signaling for the slots (flexible time units or flexible slots) corresponding to the gap 810, the gap 812, or seven slots at the end of the SMR-TBI configuration period corresponding to the illustrated SMR-TBI periodicity).

### Dynamic SMR-TBI Signaling for FWF Beam Indication

In certain embodiments disclosed herein, a base station may dynamically indicate SMR-TBI States to an SMR. The SMR may be provided, through RRC signaling over a backhaul link from the base station, a location of a TBI-index field in a DCI Format 2_Y by a positionInDCI field, and a set of SMR-TBI State combinations. Each SMR-TBI State combination in the set of SMR-TBI State combinations includes a sequence of pairs <SMR-TBI State, Duration>, and a mapping for the SMR-TBI State combination to a corresponding TBI-index field value in DCI format 2_Y.

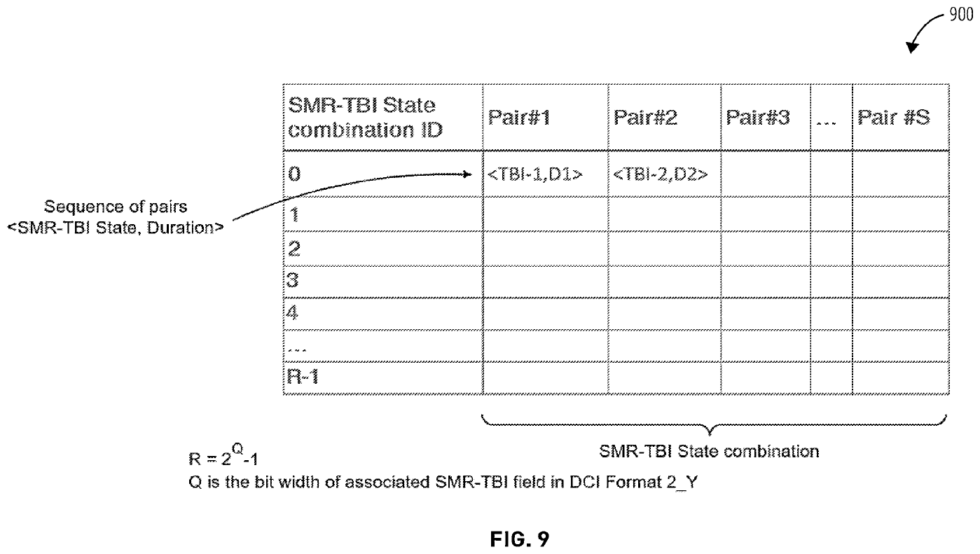

For example, FIG. 9 is a table illustrating an SMR-TBI Sate combination structure 900 according to one embodiment. The table may be configured to includes one or pairs (Pair #1, Pair #2, Pair #3, . . . , Pair #S) for each corresponding SMR-TBI State combination ID (0, 1, 2, . . . , R-1, where R=2^{Q}-1, and where Q (rounded up to the nearest integer) is a bit width of an associated SMR-TBI field in the DCI Format 2_Y). In this example, SMR-TBI State combination ID 0 includes a sequence of pairs <TBI-1,D1> and <TBI-2,D2>.

The new DCI Format 2_Y may be introduced for notifying the SMR-TBI States for SMR. The DCI Format 2_Y is identified with a dedicated RNTI, TBI-Update-RNTI, which is used to scramble the CRC bits of the DCI Format 2_Y. In certain embodiments, the DCI Format 2_Y may be group-common to target one or multiple SMRs.

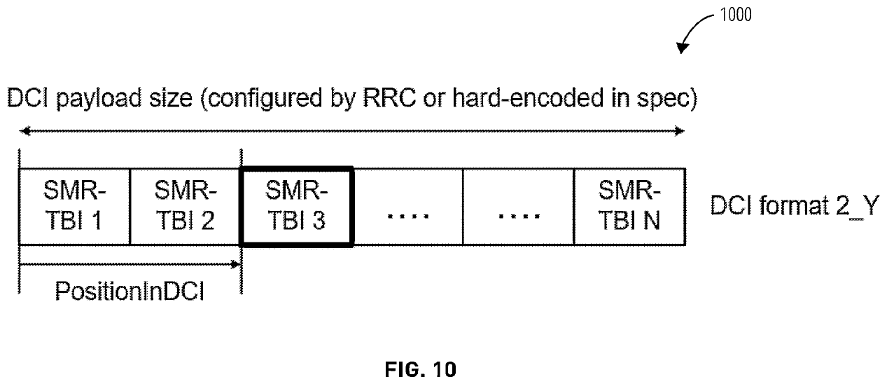

FIG. 10 illustrates an example DCI Format 2_Y 1000 for SMR-TBI State update according to one embodiment. The DCI Format 2_Y 1000 may transmit SMR-TBI indicator 1, SMR-TBI indicator 2, SMR-TBI indicator 3, . . . , SMR-TBI indicator N. The DCI payload size may be configured by RRC signaling or may be predefined (e.g., in a specification or standard). In this example, the position of SMR-TBI 3 in the DCI Format 2_Y 1000 is indicated by PositionInDCI field sent from the base station to the SMR through RRC signaling.

In certain embodiments, an SMR may be configured with a control resource set (CORESET) to monitor group-common (GC) DCI Format 2_Y. One or more CORESETs may be located, for example, in the first one, two, or three symbols in a slot. When configuring GC-PDCCH monitoring for DCI format 2_Y, the base station configures the payload length. The combination of SMR-TBI States indicated by the SMR-TBI indicator field in DCI format 2_Y is applied starting from the slot where DCI Format 2_Y is received. The duration of the SMR-TBI State combination is determined by the number of aggregated SMR-TBI States within the combination.

In certain embodiments, if the SMR is provided with an SMR-TBI configuration through RRC signaling, as discussed above, the SMR applies the indicated SMR-TBI State combinations to override the flexible time units within a SMR-TBI configuration period only. The SMR-TBI State combination configuration is provided through RRC-signaling, while the SMR-TBI State activation/deactivation is performed by a relatively faster signaling (i.e., MAC CE or DCI Format 2_X). Therefore, some of SMR-TBI States in RRC-configured SMR-TBI State combination(s) may be deactivated by the base station already.

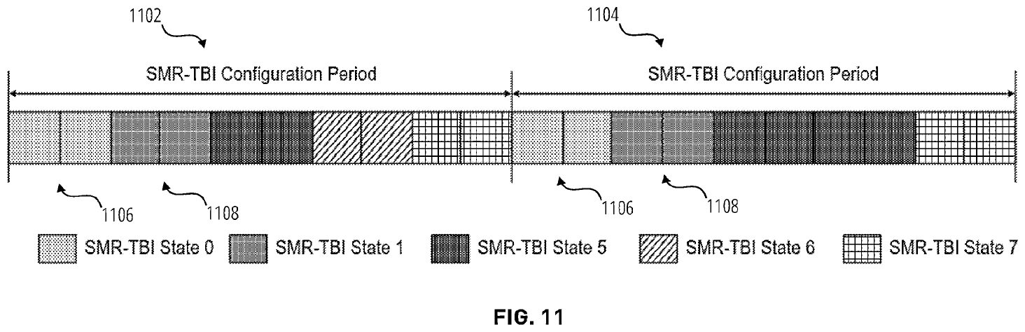

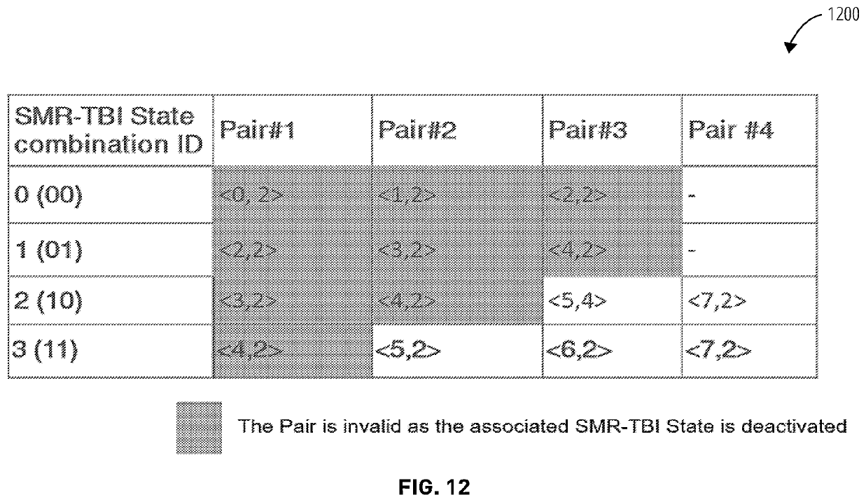

FIG. 11 and FIG. 12 illustrate an example of dynamic SMR-TBI signaling for FWF beam indication according to one embodiment. As shown in FIG. 11, an SMR is configured with a first SMR-TBI configuration period 1102 and a second SMR-TBI configuration period 1104 with ten slots each. Two slots 1106 in each period are configured with SMR-TBI State 0 and two slots 1108 in each period are configured with SMR-TBI 1. Six slots are configured using dynamic SMR-TBI signaling based on combinations of eight SMR-TBI States (SMR-TBI State 0 to SMR-TBI State 7). In certain implementations, all of the slots within an SMR-TBI configuration period may be dynamically configured by overriding the two slots 1106 previously configured with SMR-TBI State 0 and/or the two slots 1108 previously configured with SMR-TBI 1.

FIG. 12 illustrates an example table corresponding to an SMR-TBI Sate combination structure 1200 used, in this example, to configure the SMR with four SMR-TBI State combinations. Thus, the bitwidth Q of the SMR-TBI State combination indicator field may be determined as log ₂(4)=2 bits. In this example, shaded boxes in the table indicate that the corresponding pair <SMR-TBI State,Duration> is invalid as the associated SMR-TBI State is deactivated. For the first SMR-TBI configuration period 1102 and the second SMR-TBI configuration period 1104 shown in FIG. 12, the base station has activated three SMR-TBI States (i.e., SMR-TBI State 5, SMR-TBI State 6, and SMR-TBI State 7).

In this example, for the first SMR-TBI configuration period 1102 shown in FIG. 11, the base station sets the value of the SMR-TBI indicator field in DCI Format 2_Y to bits “1 1” corresponding to the SMR-TBI State combination ID 3 shown in FIG. 12 to include pairs <5,2>, <6,2>, and <7,2>. Thus, as shown in FIG. 11, the SMR is configured in the first SMR-TBI configuration period 1102 with SMR-TBI State 5 for a duration of two slots, SMR-TBI State 6 for a duration of two slots, and SMR-TBI State 7 for a duration of two slots.

For the second SMR-TBI configuration period 1104, the base station sets the value of the SMR-TBI indicator field in DCI Format 2_Y to bits “1 0” corresponding to the SMR-TBI State combination ID 2 shown in FIG. 12 to include pairs <5,4> and <7,2>. Thus, as shown in FIG. 11, the SMR is configured in the second SMR-TBI configuration period 1104 with SMR-TBI State 5 for a duration of four slots and SMR-TBI State 7 for a duration of two slots.

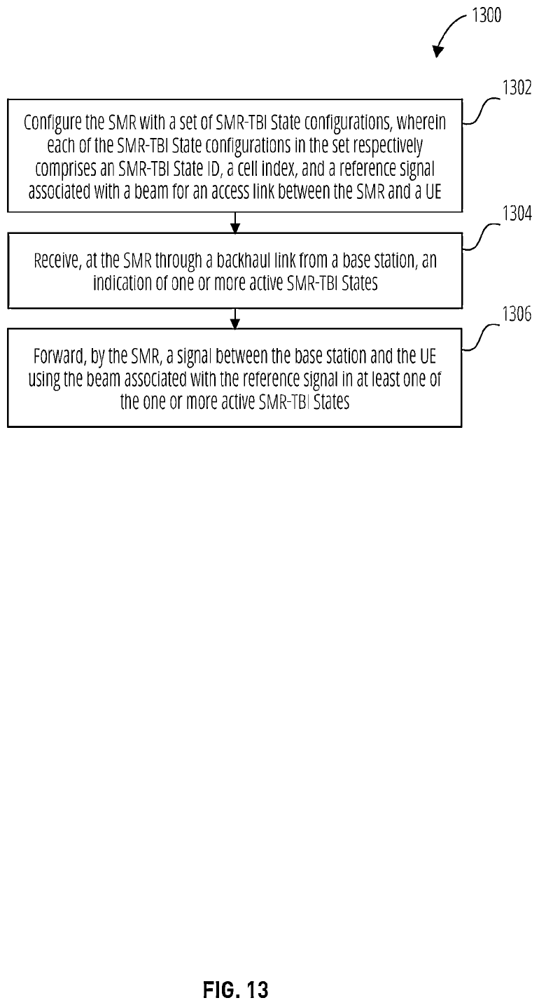

FIG. 13 is a flowchart of a method 1300 for an SMR according to one embodiment. In block 1302, the method 1300 includes configuring the SMR with a set of SMR-TBI State configurations, wherein each of the SMR-TBI State configurations in the set respectively comprises an SMR-TBI State ID, a cell index, and a reference signal associated with a beam for an access link between the SMR and a UE. In block 1304, the method 1300 includes receiving, at the SMR through a backhaul link from a base station, an indication of one or more active SMR-TBI States. In block 1306, the method 1300 includes forwarding, by the SMR, a signal between the base station and the UE using the beam associated with the reference signal in at least one of the one or more active SMR-TBI States.

In certain embodiments, the method 1300 further includes reporting, by the SMR to the base station through the backhaul link, a beam forming capability or a maximum number of SMR-TBI States capability per CC for at least one of a DL forwarding operation and a UL forwarding operation, wherein a number of the SMR-TBI State configurations in the set is based on the beam forming capability or the maximum number of SMR-TBI States capability per CC reported by the SMR.

In certain embodiments of the method 1300, the reference signal indicated in the SMR-TBI State configuration is selected from a non-zero power channel state information reference signal transmitted by the SMR (SMR-NZP-CSI-RS) and a synchronization signal block transmitted by the SMR (SMR-SSB).

In certain embodiments of the method 1300, configuring the SMR comprises receiving, at the SMR through the backhaul link from the base station, one or more RRC signals comprising the SMR-TBI configurations, wherein the SMR-TBI States configured by the SMR-TBI configurations are initially deactivated by the base station. In certain such embodiments, the method 1300 further includes receiving and processing a MAC CE transmitted from the base station indicating an activation or deactivation status of the SMR-TBI States. The MAC CE may be identified with a MAC subheader with a dedicated LCID and comprises a variable size including a serving cell ID and activation/deactivation status fields for the SMR-TBI States, and wherein the serving cell ID identifies a particular serving cell for which the MAC CE applies. The method 1300 may further include determining that the particular serving cell is configured as part of a serving cell group that includes a list of cells for an SMR-TBI States update and applying the MAC CE to the list of cells in the serving cell group.

In other embodiments, the method 1300 may further include receiving and processing a DCI format transmitted from the base station for activation and deactivation of the SMR-TBI States, wherein CRC bits of the DCI format are scrambled by a dedicated TBI RNTI that identifies the DCI format. The DCI format may include: a serving cell ID; a bitmap field with each bit indicating the activation/deactivation status for a particular SMR-TBI State within the SMR-TBI States; a PRI to indicate a PUCCH resource from a list of PUCCH resources configured by RRC signaling; and a function ID to identify the DCI format as being used for an SMR-TBI State activation/deactivation function. In certain such embodiments, the 1300 may further include performing PDCCH monitoring for the DCI format according to a search space set configuration including: a PDCCH monitoring periodicity; a PDCCH monitoring offset; and one or more CCE aggregation level determined from a predefined CCE aggregation level value or configured by the base station through RRC signaling on a per SMR basis. A monitoring occasion determined from the search space set configuration may be within a first three symbols of a single slot.

In certain embodiments, the method 1300 further includes receiving, at the SMR through the backhaul link from the base station, semi-static SMR-TBI signaling including a dedicated SMR-TBI-Configuration indicating an SMR-TBI periodicity and an SMR-TBI pattern of one or more configured SMR-TBI States over at least a portion of the SMR-TBI periodicity. The dedicated SMR-TBI-Configuration may further include a reference SCS for an associated SMR-TBI State that is used for determining time domain boundaries of the associated SMR-TBI State. In certain embodiments, the method 1300 further includes using a predetermined SCS for an associated SMR-TBI State based on a corresponding FR for a serving cell to determine time domain boundaries of an associated SMR-TBI State. In certain embodiments, the SMR-TBI pattern comprises a list of pairs wherein each pair includes a selected SMR-TBI State that is selected from the configured SMR-TBI States and a corresponding number of time units associated with the selected SMR-TBI State. The corresponding number of time units of the SMR-TBI pattern may be based on a set of time units associated with different SMR-TBI States of the SMR-TBI pattern that are continuously allocated without a gap. Alternatively, the corresponding number of time units of the SMR-TBI pattern may be based on a set of time units associated with different SMR-TBI States of the SMR-TBI pattern that are non-continuously allocated with a gap, wherein the corresponding number of time units in each pair of the list of pairs includes a starting time and a time length or an offset parameter indicates a starting time relative to an ending time of a previous SMR-TBI State.

In certain embodiments, the method 1300 further includes: receiving, at the SMR through the backhaul link from the base station, RRC signaling comprising a set of SMR-TBI State combinations and a location of an SMR-TBI indicator field in a DCI format transmitted from the base station for notifying SMR-TBI States for an SMR-TBI periodicity; and wherein each SMR-TBI State combination in the set of SMR-TBI State combinations includes a sequence of pairs wherein each pair includes an SMR-TBI State selected from the SMR-TBI States configured by the RRC signaling and a duration and a mapping for the SMR-TBI State combination to a corresponding value of the SMR-TBI indicator field in the DCI format. The DCI format may have CRC bits scrambled by a dedicated TBI update RNTI that identifies the DCI format. The DCI format may be a group-common DCI format that is used to indicate the set of SMR-TBI State combinations for one or multiple SMRs. In certain such embodiments, the method 1300 further includes: performing physical downlink control channel (PDCCH) monitoring for the group-common DCI format according to a control resource set (CORESET) located in a first one, two, or three symbols in a slot, wherein a payload size of the DCI format is configured by the base station; and applying a selected SMR-TBI State combination indicated by the SMR-TBI indicator field in the DCI format starting at a same slot where the DCI format is received, wherein a duration of the selected SMR-TBI State combination is determined by aggregating SMR-TBI State durations within the selected SMR-TBI State combination. The selected SMR-TBI State combination may be applied for flexible time units within an SMR configuration period, wherein the flexible time units are within an SMR-TBI periodicity that have no SMR-TBI State configuration provided by the RRC signaling. Applying the selected SMR-TBI State combination indicated by the SMR-TBI indicator field may include applying only the one or more active SMR-TBI States.

Embodiments contemplated herein include an apparatus comprising means to perform one or more elements of the method 1300. This apparatus may be, for example, an apparatus of a UE (such as a wireless device 1602 that is a UE, as described herein).

Embodiments contemplated herein include one or more non-transitory computer-readable media comprising instructions to cause an electronic device, upon execution of the instructions by one or more processors of the electronic device, to perform one or more elements of the method 1300. This non-transitory computer-readable media may be, for example, a memory of a UE (such as a memory 1606 of a wireless device 1602 that is a UE, as described herein).

Embodiments contemplated herein include an apparatus comprising logic, modules, or circuitry to perform one or more elements of the method 1300. This apparatus may be, for example, an apparatus of a UE (such as a wireless device 1602 that is a UE, as described herein).

Embodiments contemplated herein include an apparatus comprising: one or more processors and one or more computer-readable media comprising instructions that, when executed by the one or more processors, cause the one or more processors to perform one or more elements of the method 1300. This apparatus may be, for example, an apparatus of a UE (such as a wireless device 1602 that is a UE, as described herein).

Embodiments contemplated herein include a signal as described in or related to one or more elements of the method 1300.

Embodiments contemplated herein include a computer program or computer program product comprising instructions, wherein execution of the program by a processor is to cause the processor to carry out one or more elements of the method 1300. The processor may be a processor of a UE (such as a processor(s) 1604 of a wireless device 1602 that is a UE, as described herein). These instructions may be, for example, located in the processor and/or on a memory of the UE (such as a memory 1606 of a wireless device 1602 that is a UE, as described herein).

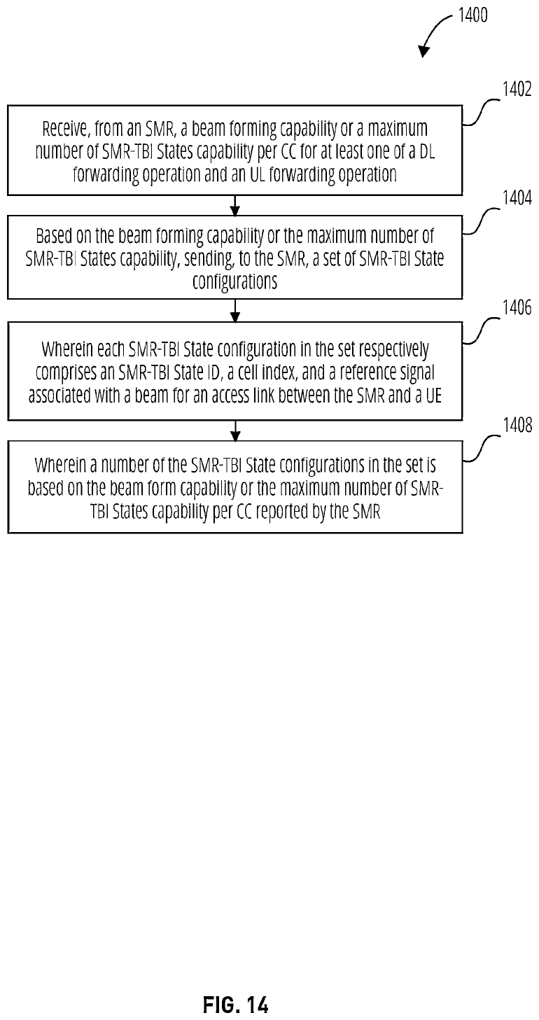

FIG. 14 is a flowchart of a method 1400 for a base station according to one embodiment. In block 1402, the method 1400 includes receiving, from an SMR, a beam forming capability or a maximum number of SMR-TBI States capability per CC for at least one of a DL forwarding operation and a UL forwarding operation. In block 1404, based on the beam forming capability or the maximum number of SMR-TBI States capability, the method 1400 includes sending, to the SMR, a set of SMR-TBI State configurations. In block 1406, the method 1400 includes wherein each SMR-TBI State configuration in the set respectively comprises an SMR-TBI State ID, a cell index, and a reference signal associated with a beam for an access link between the SMR and a UE. In block 1408, the method 1400 includes wherein a number of the SMR-TBI State configurations in the set is based on the beam forms capability or the maximum number of SMR-TBI States capability per CC reported by the SMR.

In certain embodiments of the method 1400, the reference signal is selected from a non-zero power channel state information reference signal transmitted by the SMR (SMR-NZP-CSI-RS) and a synchronization signal block transmitted by the SMR (SMR-SSB).

In certain embodiments, the method 1400 further includes: sending, from the base station to the SMR, one or more radio resource control (RRC) signals comprising the SMR-TBI configurations; and initially deactivating SMR-TBI States that are configured by the SMR-TBI configurations. In certain such embodiments, the method 1400 may further include sending, from the base station to the SMR, a MAC CE indicating an activation or deactivation status of the SMR-TBI States. The MAC CE may be identified with a MAC subheader with a dedicated LCID and may comprise a variable size including a serving cell ID and activation/deactivation status fields for the SMR-TBI States, and wherein the serving cell ID identifies a particular serving cell for which the MAC CE applies. The method 1400 may further include configuring the particular serving cell as part of a serving cell group that includes a list of cells for SMR-TB States update.

In certain embodiments, the method 1400 further includes sending, from the base station to the SMR, a DCI format for activation and deactivation of the SMR-TBI States, wherein CRC bits of the DCI format are scrambled by a dedicated TBI RNTI that identifies the DCI format. The DCI format may include: a serving cell ID; a bitmap field with each bit indicating an activation/deactivation status for a particular one of SMR-TBI States; a PRI to indicate a PUCCH resource from a list of PUCCH resources configured by RRC signaling; and a function ID to identify the DCI format as being used for an SMR-TBI State activation/deactivation function. In certain embodiments, the method 1400 further includes providing, from the base station to the SMR, a search space set configuration including: a PDCCH monitoring periodicity; a PDCCH monitoring offset; and one or more CCE aggregation level of the search space set for detection of the DCI format by the SMR. The method 1400 may further include limiting a monitoring occasion of the search space set configuration to within a first three symbols of a single slot.

In certain embodiments, the method 1400 further includes sending, from the base station to the SMR, semi-static SMR-TBI signaling including: a dedicated SMR-TBI-Configuration indicating an SMR-TBI periodicity; and an SMR-TBI pattern of one or more configured SMR-TBI States over at least a portion of the SMR-TBI periodicity. The dedicated SMR-TBI-Configuration may further include a reference SCS for an associated SMR-TBI State that is used for determining time domain boundaries of the associated SMR-TBI State. The method 1400 may further include using a predetermined SCS for an associated SMR-TBI State based on a corresponding FR for a serving cell to determine time domain boundaries of the associated SMR-TBI State. The SMR-TBI pattern may include a list of pairs wherein each pair includes a selected SMR-TBI State selected from the configured SMR-TBI States and a corresponding number of time units associated with the selected SMR-TBI State. In one embodiment, the corresponding number of time units of the SMR-TBI pattern is based on a set of time units associated with different SMR-TBI States of the SMR-TBI pattern that are continuously allocated without a gap. In another embodiment, the corresponding number of time units of the SMR-TBI pattern is based on a set of time units associated with different SMR-TBI States of the SMR-TBI pattern that are non-continuously allocated with a gap. The corresponding number of time units in each pair of the list of pairs may include a starting time and a time length. In certain embodiments, an offset parameter indicates a starting time relative to an ending time of a previous SMR-TBI State.

In certain embodiments, the method 1400 further includes: sending, from the base station to the SMR, radio resource control (RRC) signaling comprising a set of SMR-TBI State combinations and a location of an SMR-TBI indicator field in a downlink control information (DCI) format transmitted from the base station for notifying SMR-TBI States for an SMR-TBI periodicity; and wherein each SMR-TBI State combination in the set of SMR-TBI State combinations includes: a sequence of pairs wherein each pair includes an SMR-TBI State selected from the SMR-TBI States configured by the RRC signaling and a duration; and a mapping for the SMR-TBI State combination to a corresponding value of the SMR-TBI indicator field in the DCI format. The DCI format may have CRC bits scrambled by a dedicated TBI update RNTI that identifies the DCI format. The DCI format may be a group-common DCI format that is used to indicate the SMR-TBI State combinations for one or multiple SMRs. In certain embodiments, the method 1400 further includes configuring the SMR with a CORESET to enable PDCCH monitoring for the group-common DCI format, wherein the CORESET is located in a first one, two, or three symbols in a slot.

Embodiments contemplated herein include an apparatus comprising means to perform one or more elements of the method 1400. This apparatus may be, for example, an apparatus of a base station (such as a network device 1618 that is a base station, as described herein).

Embodiments contemplated herein include one or more non-transitory computer-readable media comprising instructions to cause an electronic device, upon execution of the instructions by one or more processors of the electronic device, to perform one or more elements of the method 1400. This non-transitory computer-readable media may be, for example, a memory of a base station (such as a memory 1622 of a network device 1618 that is a base station, as described herein).

Embodiments contemplated herein include an apparatus comprising logic, modules, or circuitry to perform one or more elements of the method 1400. This apparatus may be, for example, an apparatus of a base station (such as a network device 1618 that is a base station, as described herein).

Embodiments contemplated herein include an apparatus comprising: one or more processors and one or more computer-readable media comprising instructions that, when executed by the one or more processors, cause the one or more processors to perform one or more elements of the method 1400. This apparatus may be, for example, an apparatus of a base station (such as a network device 1618 that is a base station, as described herein).

Embodiments contemplated herein include a signal as described in or related to one or more elements of the method 1400.

Embodiments contemplated herein include a computer program or computer program product comprising instructions, wherein execution of the program by a processing element is to cause the processing element to carry out one or more elements of the method 1400. The processor may be a processor of a base station (such as a processor(s) 1620 of a network device 1618 that is a base station, as described herein). These instructions may be, for example, located in the processor and/or on a memory of the base station (such as a memory 1622 of a network device 1618 that is a base station, as described herein).

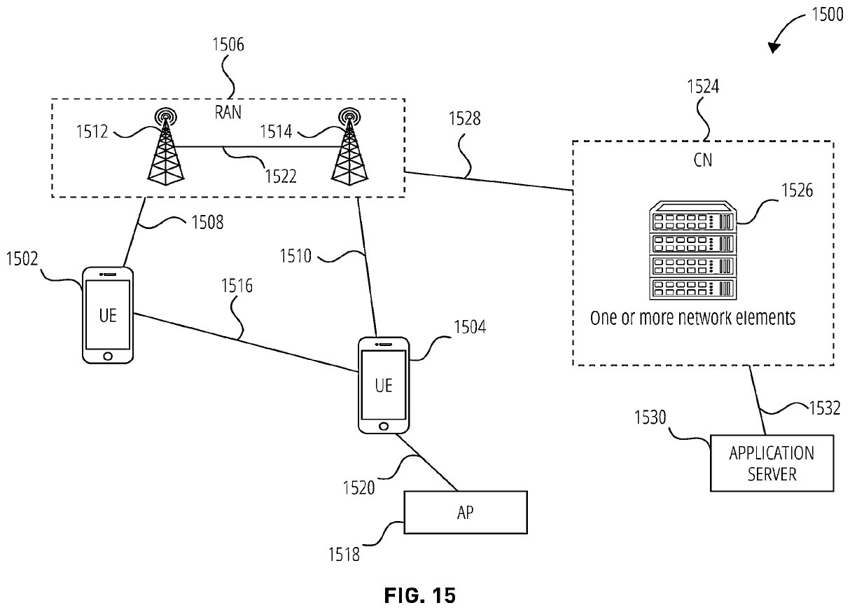

FIG. 15 illustrates an example architecture of a wireless communication system 1500, according to embodiments disclosed herein. The following description is provided for an example wireless communication system 1500 that operates in conjunction with the LTE system standards and/or 5G or NR system standards as provided by 3GPP technical specifications.

As shown by FIG. 15, the wireless communication system 1500 includes UE 1502 and UE 1504 (although any number of UEs may be used). In this example, the UE 1502 and the UE 1504 are illustrated as smartphones (e.g., handheld touchscreen mobile computing devices connectable to one or more cellular networks), but may also comprise any mobile or non-mobile computing device configured for wireless communication.

The UE 1502 and UE 1504 may be configured to communicatively couple with a RAN 1506. In embodiments, the RAN 1506 may be NG-RAN, E-UTRAN, etc. The UE 1502 and UE 1504 utilize connections (or channels) (shown as connection 1508 and connection 1510, respectively) with the RAN 1506, each of which comprises a physical communications interface. The RAN 1506 can include one or more base stations, such as base station 1512 and base station 1514, that enable the connection 1508 and connection 1510.

In this example, the connection 1508 and connection 1510 are air interfaces to enable such communicative coupling, and may be consistent with RAT(s) used by the RAN 1506, such as, for example, an LTE and/or NR.

In some embodiments, the UE 1502 and UE 1504 may also directly exchange communication data via a sidelink interface 1516. The UE 1504 is shown to be configured to access an access point (shown as AP 1518) via connection 1520. By way of example, the connection 1520 can comprise a local wireless connection, such as a connection consistent with any IEEE 802.11 protocol, wherein the AP 1518 may comprise a Wi-Fi© router. In this example, the AP 1518 may be connected to another network (for example, the Internet) without going through a CN 1524.

In embodiments, the UE 1502 and UE 1504 can be configured to communicate using orthogonal frequency division multiplexing (OFDM) communication signals with each other or with the base station 1512 and/or the base station 1514 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 1512 or base station 1514 may be implemented as one or more software entities running on server computers as part of a virtual network. In addition, or in other embodiments, the base station 1512 or base station 1514 may be configured to communicate with one another via interface 1522. In embodiments where the wireless communication system 1500 is an LTE system (e.g., when the CN 1524 is an EPC), the interface 1522 may be an X2 interface. The X2 interface may be defined between two or more base stations (e.g., two or more eNBs and the like) that connect to an EPC, and/or between two eNBs connecting to the EPC. In embodiments where the wireless communication system 1500 is an NR system (e.g., when CN 1524 is a 5GC), the interface 1522 may be an Xn interface. The Xn interface is defined between two or more base stations (e.g., two or more gNBs and the like) that connect to 5GC, between a base station 1512 (e.g., a gNB) connecting to 5GC and an eNB, and/or between two eNBs connecting to 5GC (e.g., CN 1524).

The RAN 1506 is shown to be communicatively coupled to the CN 1524. The CN 1524 may comprise one or more network elements 1526, which are configured to offer various data and telecommunications services to customers/subscribers (e.g., users of UE 1502 and UE 1504) who are connected to the CN 1524 via the RAN 1506. The components of the CN 1524 may be implemented in one physical device or separate physical devices including components to read and execute instructions from a machine-readable or computer-readable medium (e.g., a non-transitory machine-readable storage medium).

In embodiments, the CN 1524 may be an EPC, and the RAN 1506 may be connected with the CN 1524 via an S1 interface 1528. In embodiments, the S1 interface 1528 may be split into two parts, an S1 user plane (S1-U) interface, which carries traffic data between the base station 1512 or base station 1514 and a serving gateway (S-GW), and the S1-MME interface, which is a signaling interface between the base station 1512 or base station 1514 and mobility management entities (MMEs).

In embodiments, the CN 1524 may be a 5GC, and the RAN 1506 may be connected with the CN 1524 via an NG interface 1528. In embodiments, the NG interface 1528 may be split into two parts, an NG user plane (NG-U) interface, which carries traffic data between the base station 1512 or base station 1514 and a user plane function (UPF), and the S1 control plane (NG-C) interface, which is a signaling interface between the base station 1512 or base station 1514 and access and mobility management functions (AMFs).

Generally, an application server 1530 may be an element offering applications that use internet protocol (IP) bearer resources with the CN 1524 (e.g., packet switched data services). The application server 1530 can also be configured to support one or more communication services (e.g., VoIP sessions, group communication sessions, etc.) for the UE 1502 and UE 1504 via the CN 1524. The application server 1530 may communicate with the CN 1524 through an IP communications interface 1532.

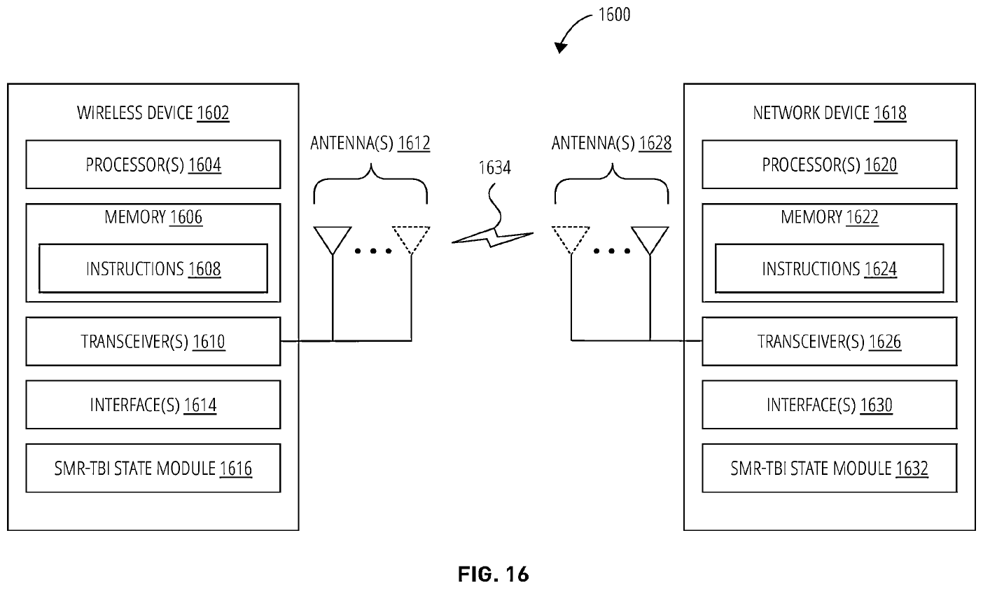

FIG. 16 illustrates a system 1600 for performing signaling 1634 between a wireless device 1602 and a network device 1618, according to embodiments disclosed herein. The system 1600 may be a portion of a wireless communications system as herein described. The wireless device 1602 may be, for example, a UE of a wireless communication system. The network device 1618 may be, for example, a base station (e.g., an eNB or a gNB) of a wireless communication system.

The wireless device 1602 may include one or more processor(s) 1604. The processor(s) 1604 may execute instructions such that various operations of the wireless device 1602 are performed, as described herein. The processor(s) 1604 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 1602 may include a memory 1606. The memory 1606 may be a non-transitory computer-readable storage medium that stores instructions 1608 (which may include, for example, the instructions being executed by the processor(s) 1604). The instructions 1608 may also be referred to as program code or a computer program. The memory 1606 may also store data used by, and results computed by, the processor(s) 1604.

The wireless device 1602 may include one or more transceiver(s) 1610 that may include radio frequency (RF) transmitter and/or receiver circuitry that use the antenna(s) 1612 of the wireless device 1602 to facilitate signaling (e.g., the signaling 1634) to and/or from the wireless device 1602 with other devices (e.g., the network device 1618) according to corresponding RATs.

The wireless device 1602 may include one or more antenna(s) 1612 (e.g., one, two, four, or more). For embodiments with multiple antenna(s) 1612, the wireless device 1602 may leverage the spatial diversity of such multiple antenna(s) 1612 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the wireless device 1602 may be accomplished according to precoding (or digital beamforming) that is applied at the wireless device 1602 that multiplexes the data streams across the antenna(s) 1612 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In certain embodiments having multiple antennas, the wireless device 1602 may implement analog beamforming techniques, whereby phases of the signals sent by the antenna(s) 1612 are relatively adjusted such that the (joint) transmission of the antenna(s) 1612 can be directed (this is sometimes referred to as beam steering).

The wireless device 1602 may include one or more interface(s) 1614. The interface(s) 1614 may be used to provide input to or output from the wireless device 1602. For example, a wireless device 1602 that is a UE may include interface(s) 1614 such as microphones, speakers, a touchscreen, buttons, and the like in order to allow for input and/or output to the UE by a user of the UE. Other interfaces of such a UE may be made up of made up of transmitters, receivers, and other circuitry (e.g., other than the transceiver(s) 1610/antenna(s) 1612 already described) that allow for communication between the UE and other devices and may operate according to known protocols (e.g., Wi-Fi®, Bluetooth®, and the like).

The wireless device 1602 may include an SMR-TBI State module 1616. The SMR-TBI State module 1616 may be implemented via hardware, software, or combinations thereof. For example, the SMR-TBI State module 1616 may be implemented as a processor, circuit, and/or instructions 1608 stored in the memory 1606 and executed by the processor(s) 1604. In some examples, the SMR-TBI State module 1616 may be integrated within the processor(s) 1604 and/or the transceiver(s) 1610. For example, the SMR-TBI State module 1616 may be implemented by a combination of software components (e.g., executed by a DSP or a general processor) and hardware components (e.g., logic gates and circuitry) within the processor(s) 1604 or the transceiver(s) 1610.

The SMR-TBI State module 1616 may be used for various aspects of the present disclosure, for example, aspects of FIG. 1 to FIG. 12. The SMR-TBI State module 1616 may be configured to perform the method 1300 shown in and described herein with respect to FIG. 13.

The network device 1618 may include one or more processor(s) 1620. The processor(s) 1620 may execute instructions such that various operations of the network device 1618 are performed, as described herein. The processor(s) 1620 may include one or more baseband processors implemented using, for example, a CPU, a DSP, an ASIC, a controller, an FPGA device, another hardware device, a firmware device, or any combination thereof configured to perform the operations described herein.

The network device 1618 may include a memory 1622. The memory 1622 may be a non-transitory computer-readable storage medium that stores instructions 1624 (which may include, for example, the instructions being executed by the processor(s) 1620). The instructions 1624 may also be referred to as program code or a computer program. The memory 1622 may also store data used by, and results computed by, the processor(s) 1620.

The network device 1618 may include one or more transceiver(s) 1626 that may include RF transmitter and/or receiver circuitry that use the antenna(s) 1628 of the network device 1618 to facilitate signaling (e.g., the signaling 1634) to and/or from the network device 1618 with other devices (e.g., the wireless device 1602) according to corresponding RATs.

The network device 1618 may include one or more antenna(s) 1628 (e.g., one, two, four, or more). In embodiments having multiple antenna(s) 1628, the network device 1618 may perform MIMO, digital beamforming, analog beamforming, beam steering, etc., as has been described.

The network device 1618 may include one or more interface(s) 1630. The interface(s) 1630 may be used to provide input to or output from the network device 1618. For example, a network device 1618 that is a base station may include interface(s) 1630 made up of transmitters, receivers, and other circuitry (e.g., other than the transceiver(s) 1626/antenna(s) 1628 already described) that enables the base station to communicate with other equipment in a core network, and/or that enables the base station to communicate with external networks, computers, databases, and the like for purposes of operations, administration, and maintenance of the base station or other equipment operably connected thereto.

The network device 1618 may include an SMR-TBI State module 1632. The SMR-TBI State module 1632 may be implemented via hardware, software, or combinations thereof. For example, the SMR-TBI State module 1632 may be implemented as a processor, circuit, and/or instructions 1624 stored in the memory 1622 and executed by the processor(s) 1620. In some examples, the SMR-TBI State module 1632 may be integrated within the processor(s) 1620 and/or the transceiver(s) 1626. For example, the SMR-TBI State module 1632 may be implemented by a combination of software components (e.g., executed by a DSP or a general processor) and hardware components (e.g., logic gates and circuitry) within the processor(s) 1620 or the transceiver(s) 1626.

The SMR-TBI State module 1632 may be used for various aspects of the present disclosure, for example, aspects of FIG. 1 to FIG. 12. The SMR-TBI State module 1632 may be configured to perform the method 1400 shown in and described herein with respect to FIG. 14.

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. A method for a smart repeater (SMR), the method comprising:
configuring the SMR with a set of SMR transmission beam indicator (TBI) state (SMR-TBI State) configurations, wherein each of the SMR-TBI State configurations in the set respectively comprises an SMR-TBI State identifier (ID), a cell index, and a reference signal associated with a beam for an access link between the SMR and a user equipment (UE);
receiving, at the SMR through a backhaul link from a base station, an indication of one or more active SMR-TBI States; and
forwarding, by the SMR, a signal between the base station and the UE using the beam associated with the reference signal in at least one of the one or more active SMR-TBI States.

2. The method of claim 1, further comprising:
reporting, by the SMR to the base station through the backhaul link, a beam forming capability or a maximum number of SMR-TBI States capability per component carrier (CC) for at least one of a downlink (DL) forwarding operation and an uplink (UL) forwarding operation,
wherein a number of the SMR-TBI State configurations in the set is based on the beam forming capability or the maximum number of SMR-TBI States capability per CC reported by the SMR.

3. The method of claim 1, wherein the reference signal indicated in the SMR-TBI State configuration is selected from a non-zero power channel state information reference signal transmitted by the SMR (SMR-NZP-CSI-RS) and a synchronization signal block transmitted by the SMR (SMR-SSB).

4. The method of claim 1, wherein configuring the SMR comprises receiving, at the SMR through the backhaul link from the base station, one or more radio resource control (RRC) signals comprising the SMR-TBI configurations, and wherein SMR-TBI States configured by the SMR-TBI configurations are initially deactivated by the base station.

5. The method of claim 4, further comprising:
receiving and processing a media access control (MAC) control element (CE) transmitted from the base station indicating an activation or deactivation status of the SMR-TBI States.

6. The method of claim 5, wherein the MAC CE is identified with a MAC subheader with a dedicated logical channel ID (LCID) and comprises a variable size including a serving cell ID and activation/deactivation status fields for the SMR-TBI States, and wherein the serving cell ID identifies a particular serving cell for which the MAC CE applies.

7. The method of claim 6, further comprising:
determining that the particular serving cell is configured as part of a serving cell group that includes a list of cells for an SMR-TBI States update; and
applying the MAC CE to the list of cells in the serving cell group.

8. The method of claim 4, further comprising:
receiving and processing a downlink control information (DCI) format transmitted from the base station for activation and deactivation of the SMR-TBI States, wherein cyclic redundancy check (CRC) bits of the DCI format are scrambled by a dedicated TBI radio network temporary identifier (RNTI) that identifies the DCI format.

9. The method of claim 8, wherein the DCI format includes:
a serving cell ID;
a bitmap field with each bit indicating an activation/deactivation status for a particular SMR-TBI State within the SMR-TBI States;
a physical uplink control channel (PUCCH) resource indicator (PRI) to indicate a PUCCH resource from a list of PUCCH resources configured by RRC signaling; and
a function ID to identify the DCI format as being used for an SMR-TBI State activation/deactivation function.

10. The method of claim 8, further comprising:
performing physical downlink control channel (PDCCH) monitoring for the DCI format according to a search space set configuration including:
a PDCCH monitoring periodicity;
a PDCCH monitoring offset; and
one or more control channel element (CCE) aggregation level determined from a predefined CCE aggregation level value or configured by the base station through RRC signaling on a per SMR basis.

11. The method of claim 10, where a monitoring occasion determined from the search space set configuration is within a first three symbols of a single slot.

12. The method of claim 1, further comprising:
receiving, at the SMR through the backhaul link from the base station, semi-static SMR-TBI signaling including:
a dedicated SMR-TBI-Configuration indicating an SMR-TBI periodicity; and
an SMR-TBI pattern of one or more configured SMR-TBI States over at least a portion of the SMR-TBI periodicity.

13. The method of claim 12, wherein the dedicated SMR-TBI-Configuration further includes a reference subcarrier spacing (SCS) for an associated SMR-TBI State that is used for determining time domain boundaries of the associated SMR-TBI State.

14. The method of claim 12, further comprising:
using a predetermined subcarrier spacing (SCS) for an associated SMR-TBI State based on a corresponding frequency range (FR) for a serving cell to determine time domain boundaries of an associated SMR-TBI State.

15. The method of claim 12, wherein the SMR-TBI pattern comprises a list of pairs wherein each pair includes a selected SMR-TBI State that is selected from the one or more configured SMR-TBI States and a corresponding number of time units associated with the selected SMR-TBI State.

16. The method of claim 15, wherein the corresponding number of time units of the SMR-TBI pattern is based on a set of time units associated with different SMR-TBI States of the SMR-TBI pattern that are continuously allocated without a gap.

17. The method of claim 15, wherein the corresponding number of time units of the SMR-TBI pattern is based on a set of time units associated with different SMR-TBI States of the SMR-TBI pattern that are non-continuously allocated with a gap.

18. The method of claim 17, wherein the corresponding number of time units in each pair of the list of pairs includes a starting time and a time length.

19. The method of claim 17, wherein an offset parameter indicates a starting time relative to an ending time of a previous SMR-TBI State.

20. The method of claim 1, further comprising:
receiving, at the SMR through the backhaul link from the base station, radio resource control (RRC) signaling comprising a set of SMR-TBI State combinations and a location of an SMR-TBI indicator field in a downlink control information (DCI) format transmitted from the base station for notifying SMR-TBI States for an SMR-TBI periodicity; and
wherein each SMR-TBI State combination in the set of SMR-TBI State combinations includes:
a sequence of pairs wherein each pair includes an SMR-TBI State selected from the SMR-TBI States configured by the RRC signaling and a duration; and
a mapping for the SMR-TBI State combination to a corresponding value of the SMR-TBI indicator field in the DCI format.

21-49. (canceled)
